(19) United States
(12) Patent Application Publication
(10) Pub. No.: US 2016/0099830 A1
(43) Pub. Date: Apr. 7, 2016

(54) DATA REROUTING AND CACHING THROUGH REDUNDANT NETWORK

(71) Applicants: Allied Telesis Holdings Kabushiki Kaisha, Tokyo (JP); ALLIED TELESIS, INC., Bothell, WA (US)

(72) Inventor: Daniel Stellick, Geneva, IL (US)

(21) Appl. No.: 14/566,487

(22) Filed: Dec. 10, 2014

Related U.S. Application Data
(63) Continuation-in-part of application No. 14/540,876, filed on Nov. 13, 2014.
Application No. 14/540,876 is a continuation-in-part of application No. 14/504,252, filed on Oct. 1, 2014.

(51) Int. Cl. H04L 12/24; H04L 12/703

(52) U.S. Cl. CPC H04L 41/0668; H04L 45/28

(57) ABSTRACT

A plurality of devices forms a communication network. The plurality of devices is networked via their respective primary link. The plurality of devices is configured to revert to a redundant network upon a primary link associated with a first device in the plurality of devices failing. A second device in the plurality of devices is configured to transmit data to the first device through the primary link associated with the first device when the primary link associated with the first device is operational. The second device is further configured to reroute the data through a secondary link associated with the first device in response to the primary link associated with the first device failing. The redundant network includes the secondary link associated with the first device.

### CROSS-REFERENCE TO RELATED APPLICATION

This application is a continuation-in-part of U.S. application Ser. No. 14/540,876, filed on 13 Nov. 2014, titled “PRIORITY DATA TRANSMISSION THROUGH REDUNDANT NETWORK” (Attorney docket no. 13-038-00-US), which is a continuation-in-part of U.S. application Ser. No. 14/504,252, filed 1 Oct. 2014, titled “REDUNDANT NETWORK FORMATION”, (Attorney Docket No. 13-036-00-US). U .S. application Ser. No. 14/540,876 and U.S. application Ser. No. 14/504,252 are incorporated by reference herein.

### BACKGROUND

A network of connected devices typically communicates information through links established among each other. In some instances, links between devices and/or devices themselves may fail, which prevents some or all devices in the network from communicating information with each other and typically results in the loss of information. In data-sensitive applications, the loss of data is undesirable.

### SUMMARY

Accordingly, a need has arisen to reroute data through a redundant network in order to prevent loss of data in the event of a link and/or device failure. For example, there is a need to cache such data when a path to the device for which the data is intended does not exist so that the data may be later sent to the device when the link and/or device is functional again.

In some embodiments, a system includes a plurality of devices that form a communication network. The plurality of devices may be networked via their respective primary link. The plurality of devices may be configured to revert to a redundant network upon a primary link associated with a first device in the plurality of devices failing. A second device in the plurality of devices may be configured to transmit data to the first device through the primary link associated with the first device when the primary link associated with the first device is operational. The second device may be further configured to reroute the data through a secondary link associated with the first device in response to the primary link associated with the first device failing. The redundant network may include the secondary link associated with the first device.

In some embodiments, the second device may be further configured to determine whether a path through the redundant network to the first device exists in case of the primary link associated with the first device failing. The second device may be further configured, in some embodiments, to select a path from a plurality of paths through the redundant network to reroute the data to the first device. It is appreciated that the selected path may include the secondary link.

In some embodiments, the primary link associated with the first device may be associated with a first communication interface. The secondary link associated with the first device may be associated with a second communication interface. It is appreciated that the first communication interface differs from the second communication interface. It is also appreciated that the first communication interface is based on a wired link, and the second communication interface is based on a wireless link. It is appreciated that the second communication interface is a radio frequency (RF) interface. It is further appreciated that the second communication interface is a Bluetooth interface.

In some embodiments, a system includes a plurality of devices that form a communication network. The plurality of devices may be networked via their respective link. First and second devices in the plurality of devices may be configured to send and receive data with each other through the communication network. The second device may be further configured to receive from the first device data destined for the second device. The first device may be further configured to cause a caching device in the plurality of devices to cache the data destined for the second device in response to the link associated with the second device failing and further in response to determining absence of an alternative path from the first device to the second device.

In some embodiments, the first device may be further configured to resume transmitting to the second device the data destined for the second device upon detecting that the link associated with the second device is functional again subsequent to the link associated with the second device failing. The first device may be further configured, in some embodiments, to cause the caching device to transmit to the second device cached data destined for the second device upon detecting that the link associated with the second device is functional again subsequent to the link associated with the second device failing.

In some embodiments, the first device may be further configured to cause another caching device in the plurality of devices to continue caching the data destined for the second device when the caching device can no longer cache the data destined for the second device. The first device may be further configured to cause another caching device in the plurality of devices to simultaneously cache a portion of the data destined for the second device while the caching device caches a remaining portion of the data destined for the second device, in some embodiments. It is appreciated that the first device and devices of the plurality of devices other than the second device may form a redundant network in response to the link associated with the second device failing.

In some embodiments, a system includes a plurality of devices that form a communication network. The plurality of devices may be networked via their respective primary link. A first device in the plurality of devices may be configured to transmit data to a second device in the plurality of devices through the primary link associated with the second device when the primary link associated with the second device is operational. The first device may be further configured to reroute the data through a redundant link associated with the second device in response to the primary link associated with the second device failing and further in response to existence of a path from the first device to the second device. The first device may be further configured to cause a caching device in the plurality of devices to cache the data in response to the primary link associated with the second device failing and further in response to absence of the path from the first device to the second device.

In some embodiments, The first device may be further configured to cause the caching device to transmit the cached data to the second device upon detecting that the primary link is functional again subsequent to the primary link associated with the second device failing. It is appreciated that the first device and devices in the plurality of devices may form a redundant network in response to the primary link associated with the second device failing.

In some embodiments, the first device may be further configured to use a plurality of different communication interfaces to reroute the data to the first device along different paths of a plurality of paths through the redundant network. It is appreciated that the plurality of different communication interfaces may include a wired interface and a wireless interface. It is also appreciated that the wireless interface is a radio frequency (RF) interface. It is additionally appreciated that the wireless interface is a Bluetooth interface.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIGS. 1A-1H show examples of data rerouted through a redundant network in accordance with some embodiments.

FIGS. 2A-2D show examples of data cached by devices in a redundant network in accordance with some embodiments.

FIGS. 3A and 3B show a flow diagram for rerouting and caching data in a redundant network in accordance with some embodiments.

FIG. 4 shows a computer system in accordance with some embodiments.

FIG. 5 shows a block diagram of a computer system in accordance with some embodiments.

### DETAILED DESCRIPTION

Reference will now be made in detail to various embodiments, examples of which are illustrated in the accompanying drawings. While various embodiments are described herein, it will be understood that these various embodiments are not intended to limit the scope of the embodiments. On the contrary, the embodiments are intended to cover alternatives, modifications, and equivalents, which may be included within the scope of the embodiments as construed according to the appended Claims. Furthermore, in the following detailed description of various embodiments, numerous specific details are set forth in order to provide a thorough understanding of the concept. However, it will be evident to one of ordinary skill in the art that the concept may be practiced without these specific details. In other instances, well known methods, procedures, components, and circuits have not been described in detail as not to unnecessarily obscure aspects of the concept and embodiments.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in an electronic device, a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “identifying,” “creating,” “generating,” “storing,” “retrieving,” “determining,” “sending,” “receiving,” “transmitting,” “communicating,” “providing,” “accessing,” “associating,” “disabling,” “enabling,” “configuring,” “initiating,” “starting,” “terminating,” “ending,” “configuring,” “forming,” “grouping,” “detecting,” “reverting,” “selecting,” “updating” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Embodiments described herein are directed to networks of devices that are configured to reroute data through a redundant network so that the data reaches its intended destination upon failure of a primary link and/or device. In one exemplary embodiment, a sending device reroutes data along a direct or indirect path through a redundant network to a receiving device. The direct or indirect path may include one or more primary links and/or secondary links in the redundant network. In some embodiments, the sending device may reroute the data along multiple direct and/or indirect paths though the redundant network to the receiving device. This manner of distributing the rerouting of data along different paths of the redundant network allows devices in the redundant network to maintain the same level of bandwidth utilization as that before the link failure occurred, maximize or increase utilization of available bandwidth, more efficiently utilize bandwidth capabilities of links, etc.

Where multiple paths are utilized for rerouting data, the different paths along which data are rerouted may include one or more shared links, in some embodiments. This way, the bandwidth capabilities of links may be more efficiently utilized. In some embodiments, a sending device may reroute data to a receiving device along multiple paths through a redundant network using different interfaces of the sending device.

In some embodiments, when a path along a redundant network between a sending device and a receiving device does not exist, data intended for the receiving device is cached in order to prevent loss of such data. The data may be cached by the sending device or another device in the redundant network. In some embodiments, multiple devices in the redundant network may simultaneously cache the data. For instance, the sending device and/or one or more devices in the redundant network may cache the data. When the link and/or device that failed is again functional, devices that cached the data may send the data to the receiving device.

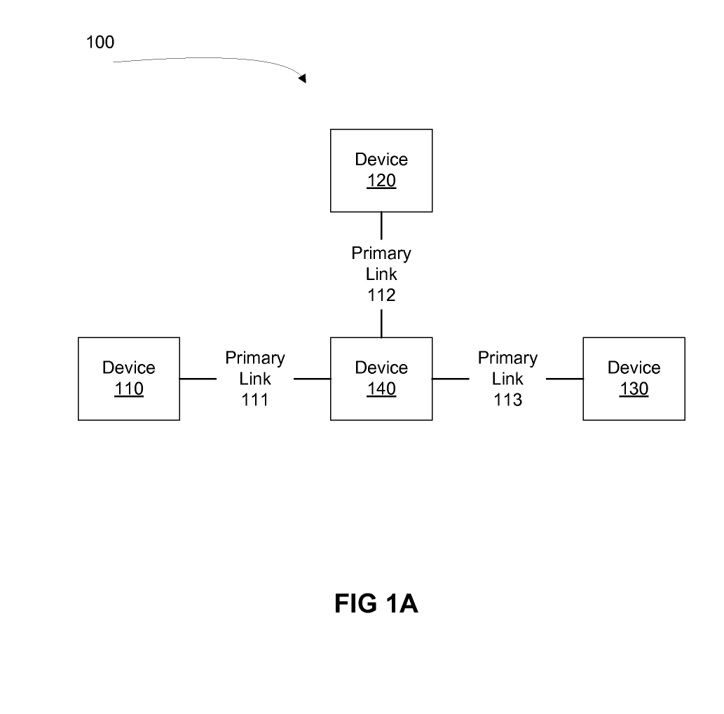

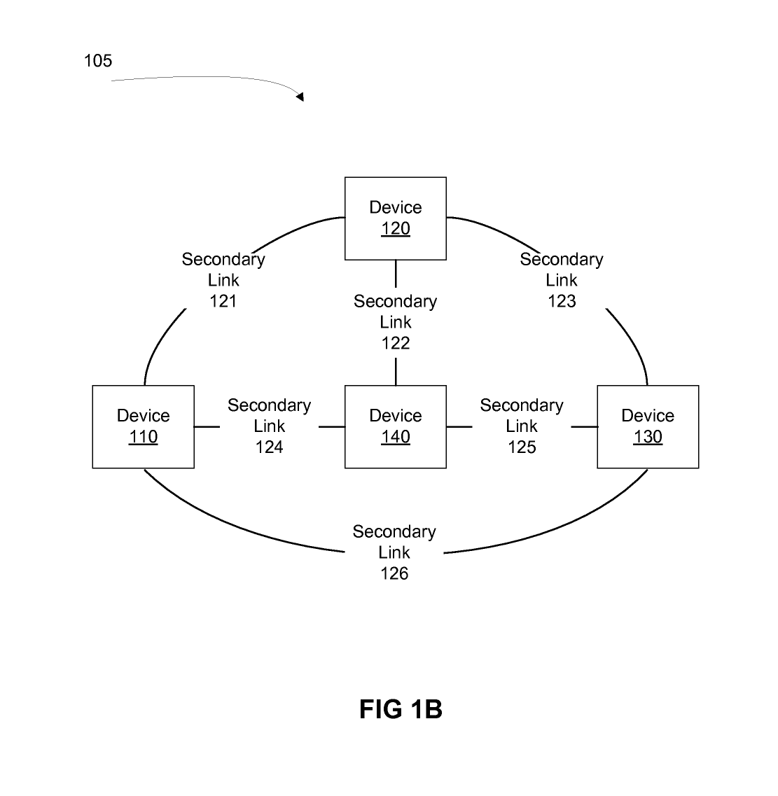

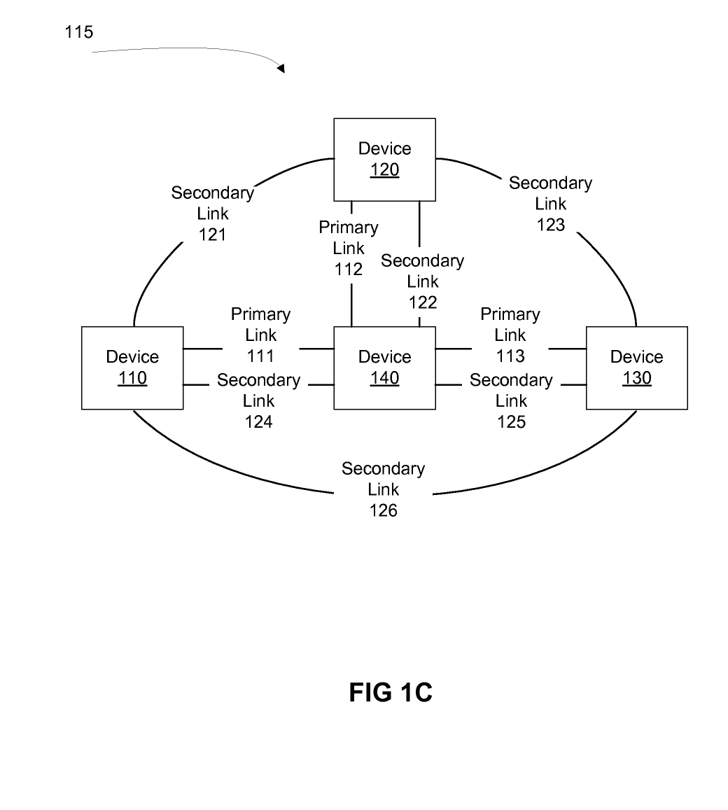

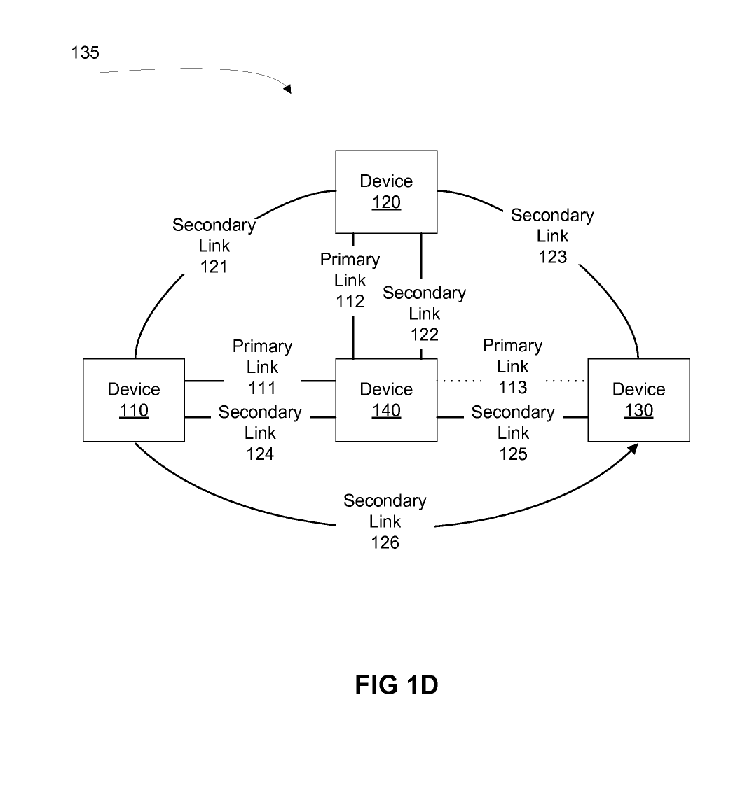

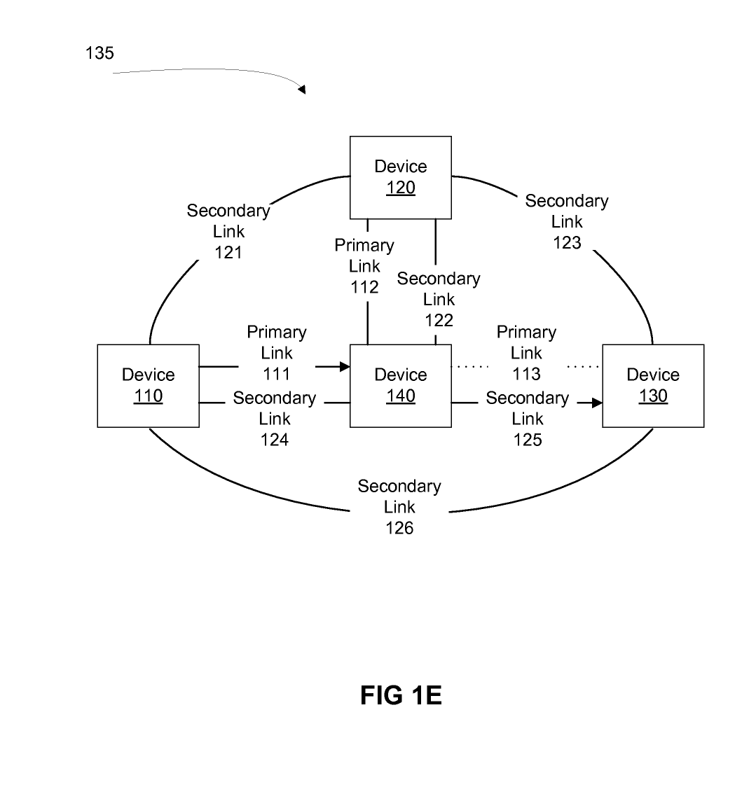

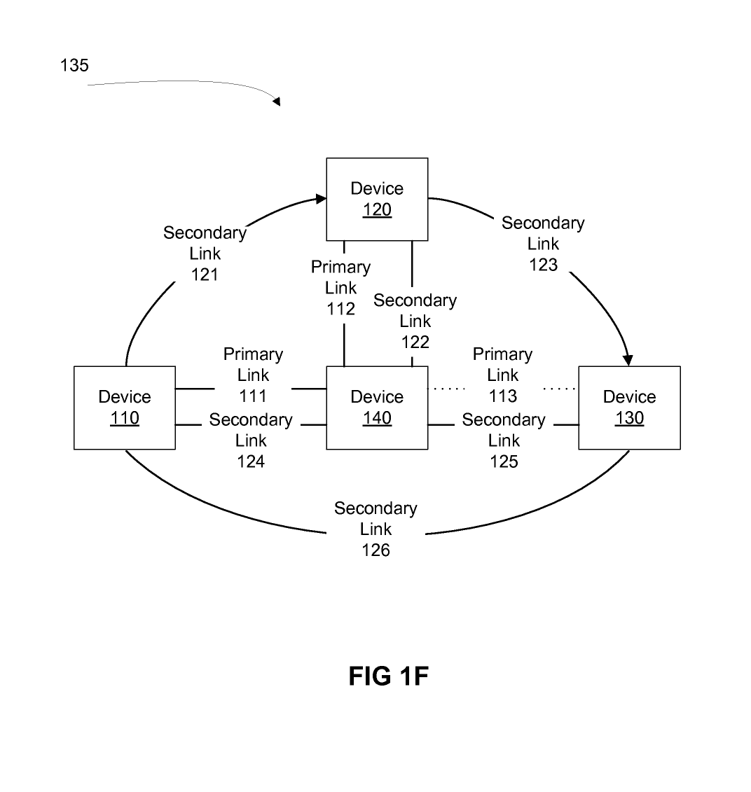

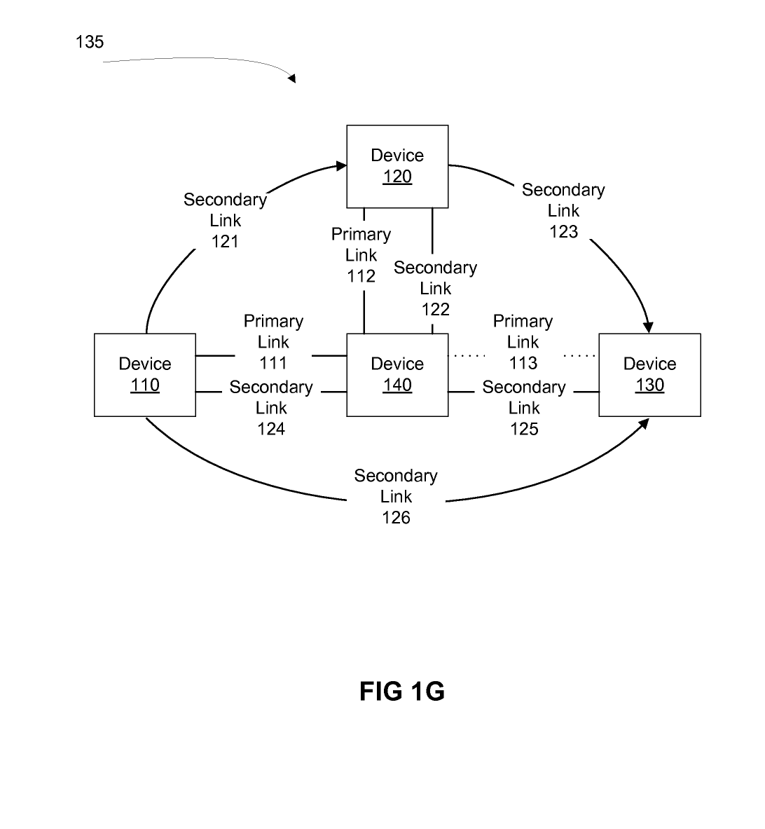

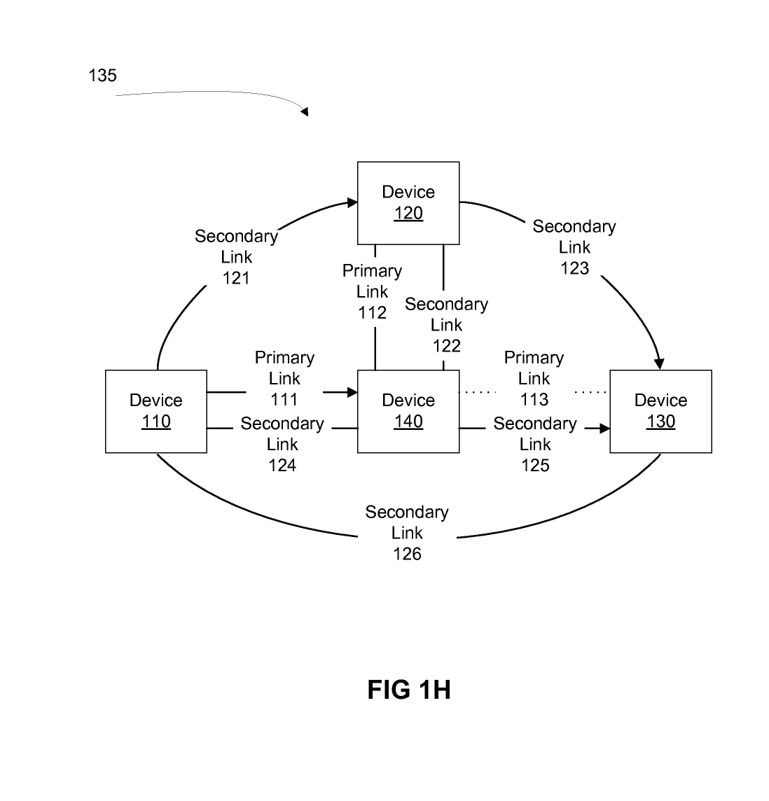

FIGS. 1A-1H show examples of data rerouted through a redundant network in accordance with some embodiments. Specifically, FIGS. 1A-1C illustrate an exemplary redundant network and FIGS. 1D-1H illustrate data being rerouted through a redundant network upon failure of a primary link. Referring now to FIG. 1A, a network 100 with primary links is shown in accordance with some embodiments. In this example, network 100 includes devices 110, 120, 130, and 140. As shown, primary link 111 couples device 110 with device 140, primary link 112 couples device 120 with device 140, and primary link 113 couples device 130 with device 140. In some embodiments, a primary link is a link coupling two devices through which the two devices use to communicate information with each other when the link is available (as opposed to other available links coupling the two devices).

Different embodiments use different methods and/or technologies for implementing primary links 111, 112, and 113 that couple devices 110, 120, 130, and 140. For instance, devices 110, 120, 130, and 140 each have a wired interface (e.g., an Ethernet interface) and primary links 111, 112, and 113 may be implemented via wired technologies (e.g., Ethernet technologies) associated with the wired interfaces in some embodiments.

It is appreciated that the devices described herein may be any type of device capable of being networked together (e.g., a sensor, an image capture device, a mobile device, a computer, a switch, a router, a hub, a bridge, etc.). In some embodiments, devices 110, 120, 130, and 140 may be the same or similar types of devices while, in other embodiments, some or all of devices 110, 120, 130, and 140 may be different types of devices. For example, each of devices 110, 120, and 130 may be a sensor (e.g., a chemical sensor, a biological sensor, a nuclear sensor, a radiological sensor, a temperature sensor, a pressure sensor, etc.) and device 140 may be a centralized computing device (e.g., a server computer) that receives (e.g., through primary links 111, 112, and 113), stores, analyzes, processes, etc., data captured by devices 110, 120, and 130. In such an example, devices 110, 120, 130, and 140, and primary links 111, 112, and 113, are arranged and function according to a star topology. It is appreciated that devices 110, 120, 130, and 140 may be arranged with primary links in any number of different topologies and/or arrangements in different embodiments.

Referring now to FIG. 1B, a network 105 with secondary links is shown in accordance with some embodiments. Specifically, network 105 illustrates secondary links coupling devices 110, 120, 130, and 140 shown in network 100 of FIG. 1A. As shown, secondary link 121 couples device 110 with device 120, secondary link 122 couples device 120 with device 140, secondary link 123 couples device 120 with device 130, secondary link 124 couples device 110 with device 140, secondary link 125 couples device 130 with device 140, and secondary link 126 couples device 110 with device 130. In some embodiments, a secondary link (also referred to as a redundant link in the present application) is a link coupling two devices through which the two devices use to communicate information with each other when a primary link coupling the two devices is unavailable (e.g., the primary link fails or degrades past a threshold level). Two devices may still use a secondary link coupling the two devices to communicate information with each other when a primary link coupling the two devices is still functional in some embodiments.

In addition, FIG. 1B illustrates an example of devices coupled to each other through secondary links according to a full mesh topology. In some embodiments, when devices are coupled using a full mesh topology, each device is coupled to every other device (i.e., a link is established between every different pair of devices). As shown in FIG. 1B, device 110 is coupled to devices 120, 130, and 140 through secondary links 121, 126, and 124; device 120 is coupled to devices 110, 130, and 140 through secondary links 121, 123, and 122; device 130 is coupled to devices 110, 120, and 140 through secondary links 126, 123, and 125; and device 140 is coupled to devices 110, 120, and 130 through secondary links 124, 122, and 125. It is appreciated that devices 110, 120, 130, and 140 may be arranged with secondary links in any number of different topologies (e.g., a partial mesh topology) and/or arrangements in different embodiments.

Different embodiments use different methods and/or technologies for implementing secondary links 121, 122, 123, 124, 125, and 126 that couple devices 110, 120, 130, and 140. For instance, in some embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11ax, Zigbee 802.15.4, Z-Wave ITU-T G.9959, RF etc.) and secondary links 121, 122, 123, 124, 125, and 126 are implemented using wireless technologies associated with the wireless interfaces. As another example, devices 110, 120, 130, and 140 may have another wired interface (e.g., a secondary Ethernet interface) and secondary links 121, 122, 123, 124, 125, and 126 are implemented using wired technologies associated with the wired interfaces.

Referring now to FIG. 1C, a network 115 with primary and secondary links is shown in accordance with some embodiments. In this example, network 115 includes devices 110, 120, 130, and 140. Moreover, devices 110, 120, 130, and 140 are coupled to each other by the primary links illustrated in FIG. 1A as well as the secondary links illustrated in FIG. 1B. That is, primary link 111 couples device 110 with device 140, primary link 112 couples device 120 with device 140, primary link 113 couples device 130 with device 140, secondary link 121 couples device 110 with device 120, secondary link 122 couples device 120 with device 140, secondary link 123 couples device 120 with device 130, secondary link 124 couples device 110 with device 140, secondary link 125 couples device 130 with device 140, and secondary link 126 couples device 110 with device 130.

Referring now to FIG. 1D, data rerouted (e.g., data routed with context awareness) directly through a secondary link of redundant network 135 is shown in accordance with some embodiments. In this example, a failure of primary link 113 in network 100 occurs and, subsequently, device 110 needs to send data to device 130 (e.g., device 110 was sending data to device 130 via primary links 111 and 113 prior to the failure of primary link 113). As illustrated in FIG. 1D, the failure of primary link 113, as indicated by a dashed line, causes devices 110, 120, 130, and 140 to revert to redundant network 135. In some embodiments, redundant network 135 includes functioning primary links and a secondary link that corresponds to each non-functioning primary link. As another example, redundant network 135 may include secondary links that couple each device to every other device. For this example, redundant network 135 includes primary links 111 and 112, and secondary links 121, 122, 123, 124, 125, and 126. It is appreciated that redundant network 135 may include any combination of primary and/or secondary links to establish a redundant path (e.g., a redundant path with data context) between any two devices. As mentioned above, in some embodiments, devices 110, 120, 130, and 140 each have a wired interface (e.g., an Ethernet interface) and primary links 111 and 112 may be implemented via wired technologies (e.g., Ethernet technologies) associated with the wired interfaces. In some such embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11ax, Zigbee 802.15.4, Z-Wave ITU-T G.9959, RF etc.) and secondary links 121, 122, 123, 124, 125, and 126 are implemented using wireless technologies associated with the wireless interfaces.

Once device 110 and/or device 140 detect that primary link 113 is no longer functioning, device 110 and/or device 140 may determine an alternate path (e.g., an alternate path with context awareness) to transmit data between devices 110 and 130. In some embodiments, primary link 113 no longer functions when primary link 113 completely fails or degrades past a threshold level. For example, device 110 may determine that at least one direct or indirect path to device 130 through redundant network 135 exists. Device 110 (e.g., with data context awareness) may then select a path through redundant network 135 to device 130 and reroute data along the selected path in order to continue transmitting data to device 130. For this example, device 110 selects a direct path to device 130 through secondary link 126. It is appreciated that, in some embodiments, device 140 may determine that at least one direct or indirect path to device 130 through network 135 exists and select the path through redundant network 135 to device 130. As shown in FIG. 1D, device 110 reroutes data directly to device 130 via secondary link 126, as indicated by an arrow along secondary link 126.

Referring now to FIG. 1E, data rerouted indirectly through primary and secondary links of redundant network 135 is shown in accordance with some embodiments. Similar to the example described above by reference to FIG. 1D, a failure of primary link 113 in network 100 occurs and, subsequently, device 110 needs to send data to device 130 (e.g., device 110 was sending data to device 130 via primary links 111 and 113 prior to the failure of primary link 113). In addition, the failure of primary link 113, as indicated by a dashed line, causes devices 110, 120, 130, and 140 to revert (e.g., with data context awareness) to redundant network 135. In some embodiments, redundant network 135 includes functioning primary links and a secondary link that corresponds to each non-functioning primary link. As another example, redundant network 135 may include secondary links that couple each device to every other device. For this example, redundant network 135 includes primary links 111 and 112, and secondary links 121, 122, 123, 124, 125, and 126. It is appreciated that redundant network 135 may include any combination of primary and/or secondary links to establish a redundant path between any two devices.

Upon device 110 and/or device 140 detecting that primary link 113 is no longer functioning, device 110 and/or device 140 may determine an alternate path to transmit data between devices 110 and 130. In some embodiments, primary link 113 no longer functions when primary link 113 completely fails or degrades past a threshold level. For instance, device 110 may determine (e.g., with data context awareness) that at least one direct or indirect path to device 130 through redundant network 135 exists. Then, device 110 may select a path through redundant network 135 to device 130 and reroute data along the selected path in order to continue transmitting data (e.g., context aware data) to device 130. In this example, device 110 selects an indirect path to device 130 through primary link 111 and secondary link 125. It is appreciated that, device 140 may determine that at least one direct or indirect path to device 130 through network 135 exists and select the path through redundant network 135 to device 130, in some embodiments. As illustrated in FIG. 1E, device 110 reroutes data indirectly to device 130 via primary link 111 and secondary link 125, as indicated by arrows along primary link 111 and secondary link 125. That is, device 110 transmits data (e.g., context aware data) destined for device 130 through primary link 111 to device 140, which in turn transmits the data through secondary link 125 to device 130.

Referring now to FIG. 1F, data rerouted indirectly through secondary links of redundant network 135 is shown in accordance with some embodiments. Similar to the example described above by reference to FIG. 1D, a failure of primary link 113 in network 100 occurs and, subsequently, device needs to send data to device 130 (e.g., device 110 was sending data to device 130 via primary links 111 and 113 prior to the failure of primary link 113). Additionally, the failure of primary link 113, as indicated by a dashed line, causes devices 110, 120, 130, and 140 (e.g., aware of the context of data) to revert to redundant network 135. In some embodiments, redundant network 135 includes functioning primary links and a secondary link that corresponds to each non-functioning primary link. As another example, redundant network 135 may include secondary links that couple each device to every other device. For this example, redundant network 135 includes primary links 111 and 112, and secondary links 121, 122, 123, 124, 125, and 126. It is appreciated that redundant network 135 may include any combination of primary and/or secondary links to establish a redundant path between any two devices. As mentioned above, in some embodiments, devices 110, 120, 130, and 140 each have a wired interface (e.g., an Ethernet interface) and primary links 111 and 112 may be implemented via wired technologies (e.g., Ethernet technologies) associated with the wired interfaces. In some such embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11ax, Zigbee 802.15.4, Z-Wave ITU-T G.9959, RF etc.) and secondary links 121, 122, 123, 124, 125, and 126 are implemented using wireless technologies associated with the wireless interfaces.

When device 110 and/or device 140 detects that primary link 113 is no longer functioning, device 110 and/or device 140 may determine an alternate path (e.g., a context aware alternate path) to transmit data between devices 110 and 130. In some embodiments, primary link 113 no longer functions when primary link 113 completely fails or degrades past a threshold level. For example, device 110 may determine that at least one direct or indirect path to device 130 through redundant network 135 exists. Device 110 may then select a path through redundant network 135 to device 130 and reroute data along the selected path in order to continue transmitting data to device 130. For this example, device 110 selects an indirect path to device 130 through secondary links 121 and 123. It is appreciated that, in some embodiments, device 140 may determine that at least one direct or indirect path to device 130 through network 135 exists and select the path through redundant network 135 to device 130. As shown in FIG. 1F, device 110 reroutes data indirectly to device 130 via secondary links 121 and 123, as indicated by arrows along secondary links 121 and 123. In other words, device 110 transmits data destined for device 130 through secondary link 121 to device 120, which in turn transmits the data through secondary link 123 to device 130.

Referring now to FIG. 1G, data rerouted directly and indirectly along multiple paths through secondary links of redundant network 135 is shown in accordance with some embodiments. Similar to the example described above by reference to FIG. 1D, a failure of primary link 113 in network 100 occurs and, subsequently, device 110 needs to send data to device 130 (e.g., device 110 was sending data to device 130 via primary links 111 and 113 prior to the failure of primary link 113). Also, the failure of primary link 113, as indicated by a dashed line, causes devices 110, 120, 130, and 140 (e.g., with context awareness) to revert to redundant network 135. In some embodiments, redundant network 135 includes functioning primary links and a secondary link that corresponds to each non-functioning primary link. As another example, redundant network 135 may include secondary links that couple each device to every other device. For this example, redundant network 135 includes primary links 111 and 112, and secondary links 121, 122, 123, 124, 125, and 126. It is appreciated that redundant network 135 may include any combination of primary and/or secondary links to establish a redundant path between any two devices. As mentioned above, in some embodiments, devices 110, 120, 130, and 140 each have a wired interface (e.g., an Ethernet interface) and primary links 111 and 112 may be implemented via wired technologies (e.g., Ethernet technologies) associated with the wired interfaces. In some such embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11ax, Zigbee 802.15.4, Z-Wave ITU-T G.9959, RF etc.) and secondary links 121, 122, 123, 124, 125, and 126 are implemented using wireless technologies associated with the wireless interfaces.

Once device 110 and/or device 140 detects that primary link 113 is no longer functioning, device 110 and/or device 140 may determine an alternate path to transmit data between devices 110 and 130. In some embodiments, primary link 113 no longer functions when primary link 113 completely fails or degrades past a threshold level. For instance, device 110 may determine that at least one direct or indirect path to device 130 through redundant network 135 exists. In some embodiments, when multiple direct and/or indirect paths to device 130 exist, device 110 may select (e.g., select with context) several paths through redundant network 135 to device 130 and reroute data along the several selected paths in order to continue transmitting data to device 130. In this example, device 110 selects an indirect path and a direct path to device 130 through secondary links 121, 123, and 126. It is appreciated that, in some embodiments, device 140 may determine that at least one direct or indirect path to device 130 through network 135 exists and select the path through redundant network 135 to device 130. As illustrated in FIG. 1G, device 110 reroutes data indirectly to device 130 via secondary links 121 and 123, as indicated by arrows along secondary links 121 and 123, in the same or similar manner described above by reference to FIG. 1F. In addition, device 110 reroutes data directly to device 130 through secondary link 126, as indicated by an arrow along secondary link 126.

Referring now to FIG. 1H, data rerouted indirectly along multiple paths through primary and secondary links of redundant network 135 is shown in accordance with some embodiments. Similar to the example described above by reference to FIG. 1D, a failure of primary link 113 in network 100 occurs and, subsequently, device 110 needs to send data to device 130 (e.g., device 110 was sending data to device 130 via primary links 111 and 113 prior to the failure of primary link 113). In addition, the failure of primary link 113, as indicated by a dashed line, causes devices 110, 120, 130, and 140 to revert to redundant network 135. In some embodiments, redundant network 135 includes functioning primary links and a secondary link that corresponds to each non-functioning primary link. As another example, redundant network 135 may include secondary links that couple each device to every other device. For this example, redundant network 135 includes primary links 111 and 112, and secondary links 121, 122, 123, 124, 125, and 126. It is appreciated that redundant network 135 may include any combination of primary and/or secondary links to establish a redundant path between any two devices. As mentioned above, in some embodiments, devices 110, 120, 130, and 140 each have a wired interface (e.g., an Ethernet interface) and primary links 111 and 112 may be implemented via wired technologies (e.g., Ethernet technologies) associated with the wired interfaces. In some such embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11ax, Zigbee 802.15.4, Z-Wave ITU-T G.9959, RF etc.) and secondary links 121, 122, 123, 124, 125, and 126 are implemented using wireless technologies associated with the wireless interfaces.

Upon device 110 and/or device 140 detecting that primary link 113 is no longer functioning, device 110 and/or device 140 may determine an alternate path to transmit data between devices 110 and 130. In some embodiments, primary link 113 no longer functions when primary link 113 completely fails or degrades past a threshold level. For example, device 110 may determine that at least one direct or indirect path to device 130 through redundant network 135 exists. As mentioned above, when multiple direct and/or indirect paths to device 130 exist, device 110 may select several paths through redundant network 135 to device 130 and reroute data along the several selected paths in order to continue transmitting data to device 130, in some embodiments. For this example, device 110 selects two indirect paths to device 130 through primary link 111 and secondary links 121, 123, and 125. It is appreciated that device 140 may determine that at least one direct or indirect path to device 130 through network 135 exists and select the path through redundant network 135 to device 130m, in some embodiments. As shown in FIG. 1H, device 110 reroutes data indirectly to device 130 via secondary links 121 and 123, as indicated by arrows along secondary links 121 and 123, in the same or similar manner described above by reference to FIG. 1F. In addition, device 110 reroutes data indirectly to device 130 through primary link 111 and secondary link 125, as indicated by arrows along primary link 111 and secondary link 126, in the same or similar manner described above by reference to FIG. 1E.

The examples described above by reference to FIGS. 1G and 1H show a device rerouting data destined for another device along multiple paths through a redundant network. It is appreciated that distributing the rerouting of data along different paths of the redundant network allows devices in the redundant network to maintain the same level of bandwidth utilization as that before the link failure occurred, maximize or increase utilization of available bandwidth, more efficiently utilize bandwidth capabilities of links, etc.

It is appreciated that data may be rerouted (e.g., rerouted with context) along any number of different and/or additional paths. Referring back to FIG. 1G for an example, device 110 may reroute data to device 130 along a path through redundant network 135 via primary link 111 and secondary link 125 in addition to, or in lieu of one of, the two paths illustrated in FIG. 1G. It is also appreciated that the different paths along which data are rerouted may include one or more shared links (e.g., to more efficiently utilize bandwidth capabilities of links). Referring back to FIG. 1H as an example, device 110 may reroute data to device 130 along different paths that share primary link 111, e.g., a path via primary link 111 and secondary link 125, as illustrated, and another path via primary links 111 and 112, and secondary link 123.

In some embodiments, a device reroutes data to another device along several paths through a redundant network using different interfaces of the device. Referring again to FIG. 1H as an example, device 110 selected two indirect paths to device 130 through primary and secondary links of redundant network 135, as mentioned above. In particular, device 110 reroutes data indirectly to device 130 through primary link 111, which is implemented using a first interface (e.g., an Ethernet interface) of device 110, and reroutes data indirectly to device 130 through secondary link 121, which is implemented using a second, different interface (e.g., an RF interface such as a Wi-Fi interface) of device 110. It is appreciated that a device may reroute data (e.g., reroute data with context) to another device along any number of different and/or additional paths using any number of different interfaces of the device.

The above-described FIGS. 1D-1H illustrate examples of paths selected for transmitting data through a redundant network from one device to another device when a primary link fails. It is appreciated that the path(s) may be selected in any number of different ways and based on any number of different criteria. For instance, in some embodiments, a path for some or all of the data may be selected based on context including, but not limited to, heuristics, path distance, the number of links in the path, device capabilities, etc. In addition, a path may be selected in order to maximize bandwidth utilization in the redundant network, maximize device utilization, increase transmission speeds, information security policies, etc., in some embodiments.

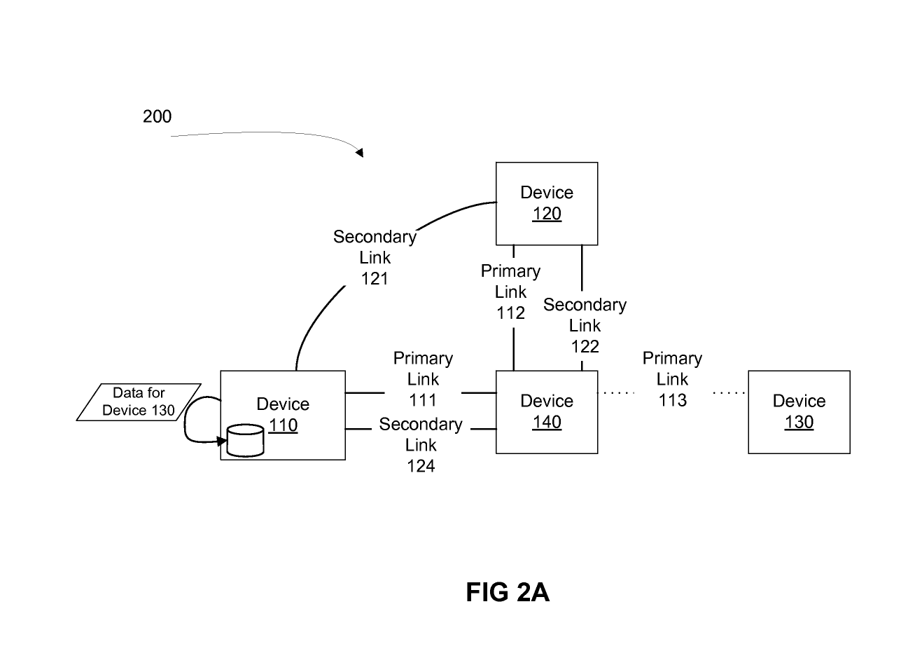

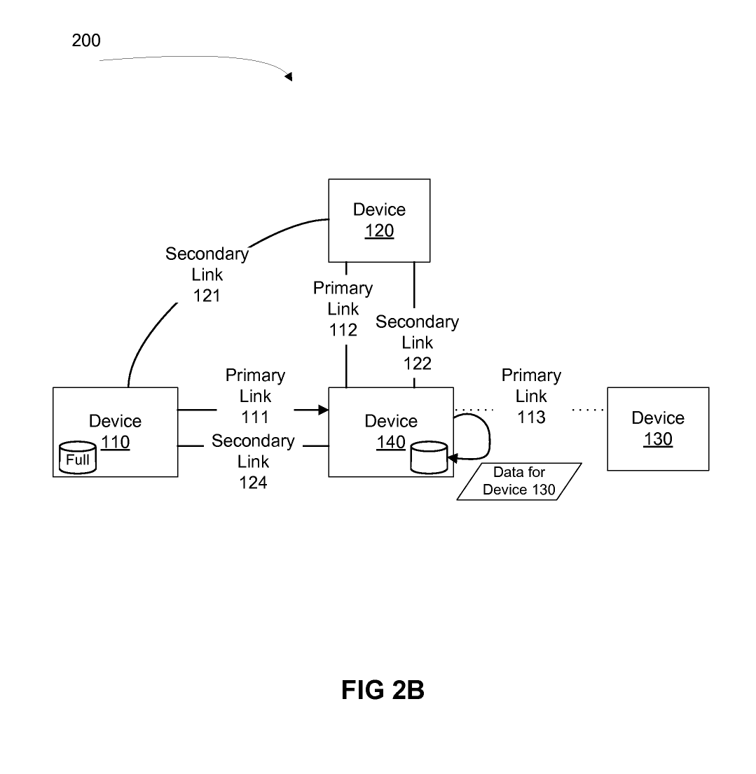

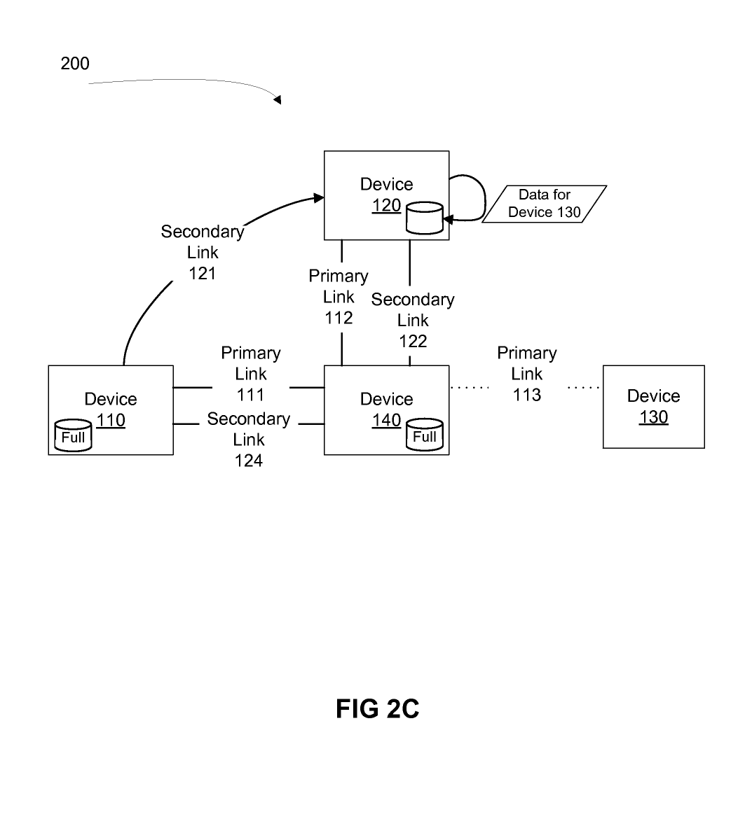

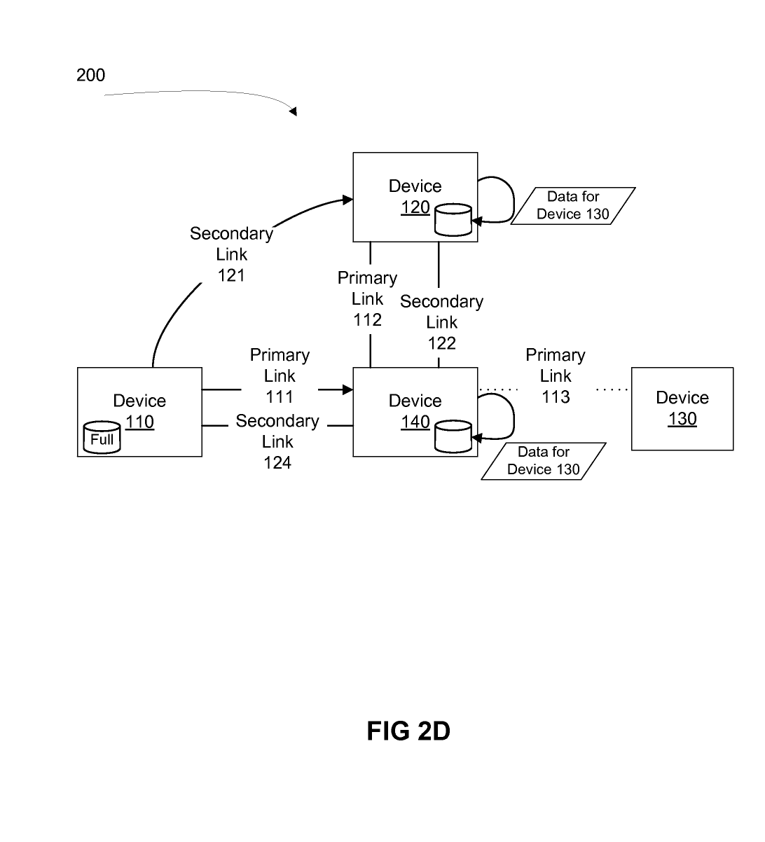

The figures described above illustrate examples and embodiments of rerouting data from one device to another device when a path through the redundant network exists between the devices. In some embodiments, when a path between one device and another device does not exist, data intended for the other device may be cached in order to prevent loss of such data. Referring now to FIG. 2A, data cached by a device in a redundant network 200 is shown in accordance with some embodiments. In this example, a failure of primary link 113 in network 100 occurs and, subsequently, device 110 needs to send data to device 130 (e.g., device 110 was sending data to device 130 via primary links 111 and 113 prior to the failure of primary link 113). The failure of primary link 113, as indicated by a dashed line, causes devices 110, 120, 130, and 140 to revert to redundant network 200. In some embodiments, redundant network 200 includes functioning primary links and a secondary link that corresponds to each non-functioning primary link. As another example, redundant network 200 may include secondary links that couple each device to every other device. For this example, redundant network 200 includes primary links 111 and 112, and secondary links 121, 122, and 124. It is appreciated that redundant network 200 may include any combination of primary and/or secondary links to establish a redundant path between any two devices. As mentioned above, in some embodiments, devices 110, 120, 130, and 140 each have a wired interface (e.g., an Ethernet interface) and primary links 111 and 112 may be implemented via wired technologies (e.g., Ethernet technologies) associated with the wired interfaces. In some such embodiments, devices 110, 120, 130, and 140 have the same type of, or a compatible, wireless interface (e.g., Wi-Fi, Bluetooth, Zigbee, Z-Wave, etc.) and secondary links 121, 122, and 124 are implemented using wireless technologies associated with the wireless interfaces.

Once device 110 and/or device 140 detects that primary link 113 is no longer functioning, device 110 and/or device 140 may determine that a path to device 130 through network 200 does not exist. In some embodiments, primary link 113 no longer functions when primary link 113 completely fails or degrades past a threshold level. Device 110 may then identify a device in redundant network 200 to cache data intended for device 130. For this example, device 110 identified itself as the device to cache the data. It is appreciated that, in some embodiments, device 140 may identify the device in redundant network to cache data intended for device 130. As shown in FIG. 2A, device 110 caches data intended for device 130 in a storage of device 110 in order to prevent loss of the data. Device 110 continues to cache such data while primary link 113 is not functional. If device 110 and/or device 140 detects that primary link 113 is functional while device 110 is caching the data intended for device 130, device 110 may stop caching the data and instead send the data to device 130 (e.g., via primary links 111 and 113). Additionally, device 110 may send data intended for device 130 that is cached in its storage to device 130 (e.g., via primary links 111 and 113).

Referring now to FIG. 2B, data cached by another device in redundant network 200 is shown in accordance with some embodiments. The example illustrated in FIG. 2B continues from the example described above by reference to FIG. 2A. Specifically, device 110 determines that it can no longer cache data intended for device 130 (e.g., the storage of device 110 has reached a maximum or threshold capacity level), as indicated by a “Full” label on the storage of device 110. In response to determining that data intended for device 130 can no longer be cached, device 110 may identify another device in redundant network 200 (e.g., a device communicatively coupled to device 110) to continue caching data intended for device 130. In this example, device 110 identified device 140 as the device to continue caching the data and directs device 140 to do so accordingly. As illustrated in FIG. 2B, device 110 sends data intended for device 130 to device 140 via primary link 111, as indicated by an arrow along primary link 111. Device 140 caches the received data in a storage of device 140 in order to prevent loss of the data intended for device 130. Device 110 continues to send device 140 such data to cache while primary link 113 is not functional. If device 110 and/or device 140 detects that primary link 113 is functional while device 140 is caching the data intended for device 130, device 110 may stop sending the data to device 140 for caching and instead send the data to device140 for forwarding to device 130. In addition, device 110 may notify device 140 to send data intended for device 130 that is cached in its storage to device 130 (e.g., via primary link 113).

The example illustrated in FIG. 2B shows device 140 directed to cache data intended for device 130 when device 110 can no longer cache the data. It is appreciated that device 110 may initially direct device 140 to cache the data when device 110 and/or device 140 detected the failure of primary link 113.

Referring now to FIG. 2C, data cached by yet another device in redundant network 200 is shown in accordance with some embodiments. The example illustrated in FIG. 2C continues from the example described above by reference to FIG. 2B. In particular, device 140 notified device 110 that it can no longer cache data intended for device 130 (e.g., the storage of device 140 has reached a maximum or threshold capacity level), as indicated by a “Full” label on the storage of device 140. In response to determining that data intended for device 130 can no longer be cached, device 110 may identify yet another device in redundant network 200 (e.g., a device communicatively coupled to device 110) to continue caching data intended for device 130. For this example, device 110 identified device 120 as the device to continue caching the data and directs device 120 to do so accordingly. As shown in FIG. 2C, device 110 sends data intended for device 130 to device 140 via secondary link 121, as indicated by an arrow along secondary link 121. Device 120 caches the received data in a storage of device 120 in order to prevent loss of the data intended for device 130. Device 110 continues to send device 120 such data to cache while primary link 113 is not functional. If device 110 and/or device 140 detects that primary link 113 is functional while device 120 is caching the data intended for device 130, device 110 may stop sending the data to device 120 and instead send the data to device 130 (e.g., via primary links 111 and 113). Additionally, device 110 may notify device 120 to send data intended for device 130 that is cached in its storage to device 130 (e.g., via primary links 112 and 113).

The example illustrated in FIG. 2C shows device 120 directed to cache data intended for device 130 when devices 110 and 140 can no longer cache the data. It is appreciated that device 110 may initially direct device 120 to cache the data when device 110 and/or device 140 detects the failure of primary link 113. It is also appreciated that device 110 may direct device 120 (instead of device 140, as illustrated in FIG. 2B) to cache data intended for device 130 when device 110 can no longer cache the data.

Referring now to FIG. 2D, data cached by multiple devices in redundant network 200 is shown in accordance with some embodiments. The example illustrated in FIG. 2D continues from the example described above by reference to FIG. 2A. Specifically, device 110 determines that it can no longer cache data intended for device 130 (e.g., the storage of device 110 has reached a maximum or threshold capacity level), as indicated by a “Full” label on the storage of device 110. In response to determining that data intended for device 130 can no longer be cached, device 110 may identify multiple devices in redundant network 200 (e.g., devices communicatively coupled to device 110) to continue caching data intended for device 130. In this example, device 110 identified devices 120 and 140 as the devices to continue caching the data and directs devices 120 and 140 to do so accordingly. As shown in FIG. 2D, device 110 sends data intended for device 130 to devices 120 and 140 via secondary link 121 and primary link 111, respectively, as indicated by arrows along secondary link 121 and primary link 111. Devices 120 and 140 cache the received data in respective storages of devices 120 and 140 in order to prevent loss of the data intended for device 130. Device 110 continues to send devices 120 and 140 such data to cache while primary link 113 is not functional. If device 110 and/or device 140 detects that primary link 113 is functional while devices 120 and 140 are caching the data intended for device 130, device 110 may stop sending the data to device 120 and instead send the data to device 130 (e.g., via primary links 111 and 113). Device 110 may also stop sending the data to device 140 for caching and instead send the data to device140 for forwarding to device 130. Additionally, device 110 may notify devices 120 and 140 to send data intended for device 130 that is cached in the respective storages of devices 120 and 140 to device 130 (e.g., via primary links 112 and 113).

The example illustrated in FIG. 2D shows devices 120 and 140 directed to cache data intended for device 130 when device 110 can no longer cache the data. It is appreciated that device 110 may initially direct devices 120 and 140 to cache the data when device 110 and/or device 140 detects the failure of primary link 113. In addition, it is appreciated that device 110 may initially direct any number of different devices (e.g., devices communicatively coupled to device 110 and/or device 110 itself) to cache the data when device 110 and/or device 140 detects the failure of primary link 113. For instance, device 110 may initially direct device 120, device 140, and/or itself to cache the data when device 110 and/or device 140 detects the failure of primary link 113. In this manner, device 110 may distribute the caching of the data among devices in redundant network 200.

FIGS. 2A-2D show storages used for caching data as part of devices. It is appreciated that such storages may be external to the devices. For example, the devices may cache the data in external hard disk drives, flash drives, solid state drives, a server, a cloud computing service, etc., in some embodiments.

FIGS. 2B-2D illustrate device 110 sending data to other devices in redundant network 200 along a particular path through redundant network 200. It is appreciated that device 110 may send the data along any number of different and/or additional paths. Referring back to FIG. 2C as an example, device may send data to device 120 along a path through redundant network 200 via primary links 111 and 112 in addition to, or in lieu of, the shown path via secondary link 121.

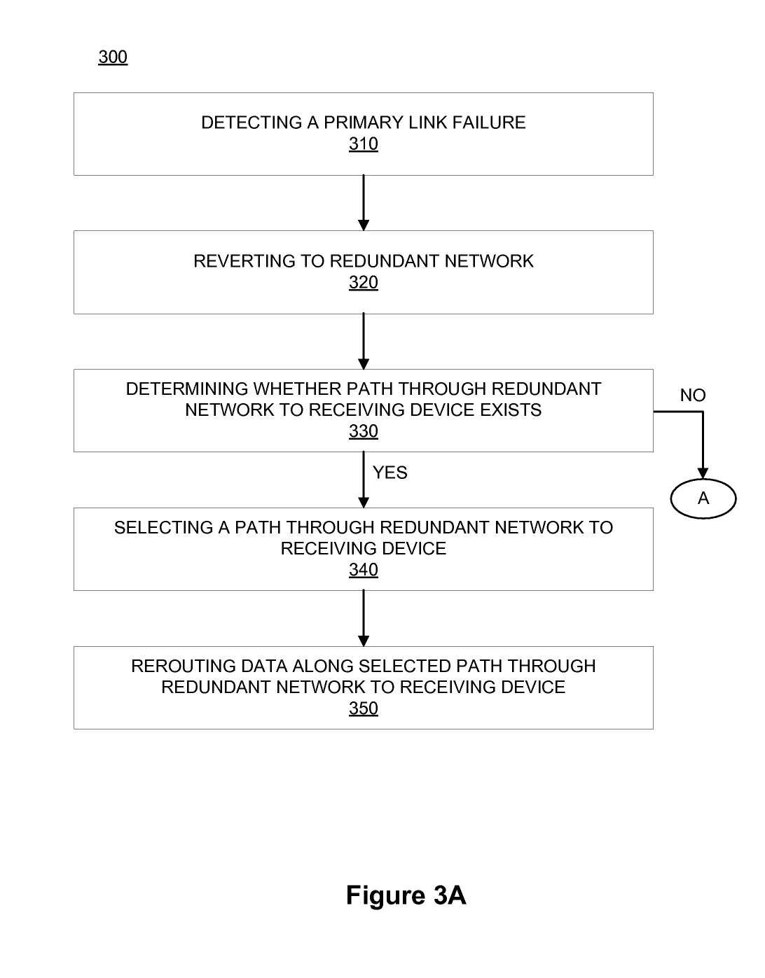

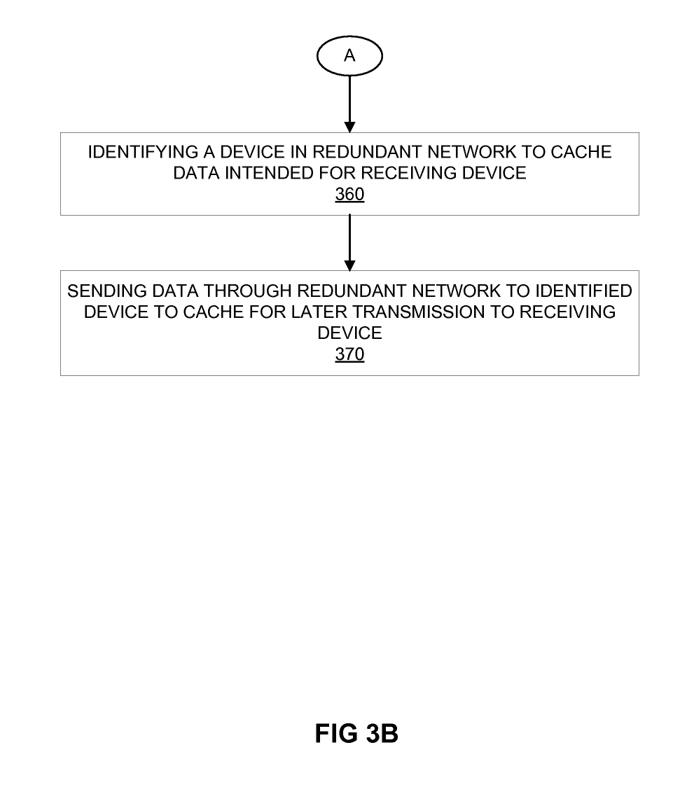

FIGS. 3A and 3B show a flow diagram for rerouting and caching data in a redundant network in accordance with some embodiments. In some embodiments, a device (e.g., device 110 and/or device 140 described above by reference to FIGS. 1D-1H) sending data to another device performs the operations described in FIGS. 3A and 3B. At step 310, a primary link failure is detected. In some embodiments, the primary link failure is detected while sending data to a receiving device. In some embodiments, a primary link failure is detected when the primary link no longer functions or degrades past a threshold level. Referring to FIG. 1D as an example, device 110 detects failure of primary link 113 while sending data to device 130.

At step 320, reversion to a redundant network occurs. Referring to FIG. 1D as an example, when primary link 113 fails, device 110 (along with devices 120, 130, and 140) revert to redundant network 135 with primary links 111 and 112, and secondary links 121, 122, 123, 124, 125, and 126. After reverting to the redundant network, at step 330, it is determined whether a path through the redundant network to the receiving device exists.

If a path through the redundant network to the receiving device is determined to exist, at step 340, a path through the redundant network to the receiving device is selected. In some embodiments, a path is selected based on heuristics, bandwidth utilization in the redundant network, device utilization, transmission speeds, path distance, a number of links in the path, etc. As mentioned above, the path may be a direct path to the receiving device or an indirect path to the receiving device. In some embodiments, multiple direct and/or indirect paths through the redundant network to the receiving device may be selected. Once a path is selected, data is rerouted along the selected path through the redundant network to the receiving device at step 350.

If a path through the redundant network to the receiving device is determined to not exist, at step 360 illustrated in FIG. 3B, a device in the redundant network to cache data intended for the receiving device is identified. As described above, a device communicatively coupled to the sending device or the sending device itself may be identified. In some embodiments, multiple devices may be identified. For instance, one or more devices communicatively coupled to the sending device and/or the sending device itself may be identified. After identifying a device, data is sent through the redundant network to the receiving device to cache for later transmission to the receiving device at step 450 (e.g., when the failed link functional again).

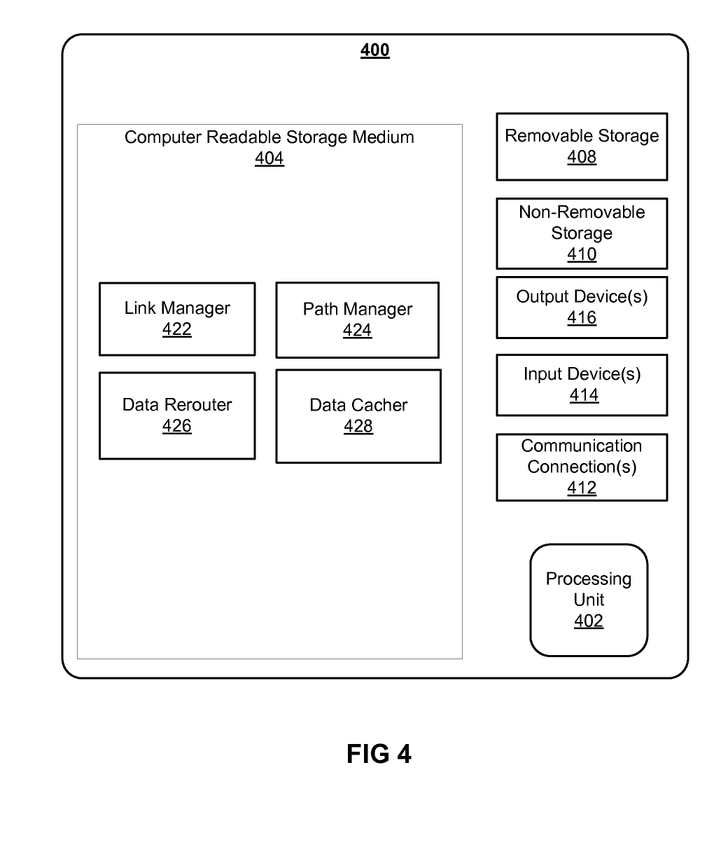

Referring now to FIG. 4, a block diagram of a computer system in accordance with some embodiments is shown. With reference to FIG. 4, a system module for implementing embodiments includes a general purpose computing system environment, such as computing system environment 400. Computing system environment 400 may include, but is not limited to, servers, switches, routers, desktop computers, laptops, tablets, mobile devices, and smartphones. In its most basic configuration, computing system environment 400 typically includes at least one processing unit 402 and computer readable storage medium 404. Depending on the exact configuration and type of computing system environment, computer readable storage medium 404 may be volatile (such as RAM), non-volatile (such as ROM, flash memory, etc.) or some combination of the two. Portions of computer readable storage medium 404 when executed facilitate the determination of device capabilities, the determination of configuration data, and the configuration of devices in order to establish redundant links (e.g., process 300).

Additionally, in various embodiments, computing system environment 400 may also have other features/functionality. For example, computing system environment 400 may also include additional storage (removable and/or non-removable) including, but not limited to, magnetic or optical disks or tape. Such additional storage is illustrated by removable storage 408 and non-removable storage 410. Computer storage media includes volatile and nonvolatile, removable and non-removable media implemented in any method or technology for storage of information such as computer readable instructions, data structures, program modules or other data. Computer readable medium 404, removable storage 408 and nonremovable storage 410 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 400. Any such computer storage media may be part of computing system environment 400.

In some embodiments, computing system environment 400 may also contain communications connection(s) 412 that allow it to communicate with other devices. Communications connection(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 412 may allow computing system environment 400 to communicate over various networks types including, but not limited to, fibre channel, small computer system interface (SCSI), Bluetooth, Zigbee, Z-Wave, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 412 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 400 may also have input device(s) 414 such as keyboard, mouse, a terminal or terminal emulator (either connected or remotely accessible via telnet, SSH, http, SSL, etc.), pen, voice input device, touch input device, remote control, etc. Output device(s) 416 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, computer readable storage medium 404 includes a link manager module 422, a path manager module 424, a data rerouter module 426, and a data cacher module 428. The link manager module 422 is operable to detect link failures and revert to redundant networks according to flow diagram 300, for instance. The path manager module 424 may be used to determine whether paths through redundant networks to a device exists according to flow diagram 300, for instance. The data rerouter module 426 operates to select paths through redundant networks to reroute data to a device as described above by reference to FIGS. 1D-1H and flow diagram 300, for instance. The data cacher module 428 is operable to identify devices in redundant networks to cache data intended for a receiving device as described above by reference to FIGS. 2A-2D and flow diagram 300, for instance.

It is appreciated that implementations according to some embodiments that are described with respect to a computer system are merely exemplary and not intended to limit the scope of the embodiments. For example, some embodiments may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams 300 and 400.

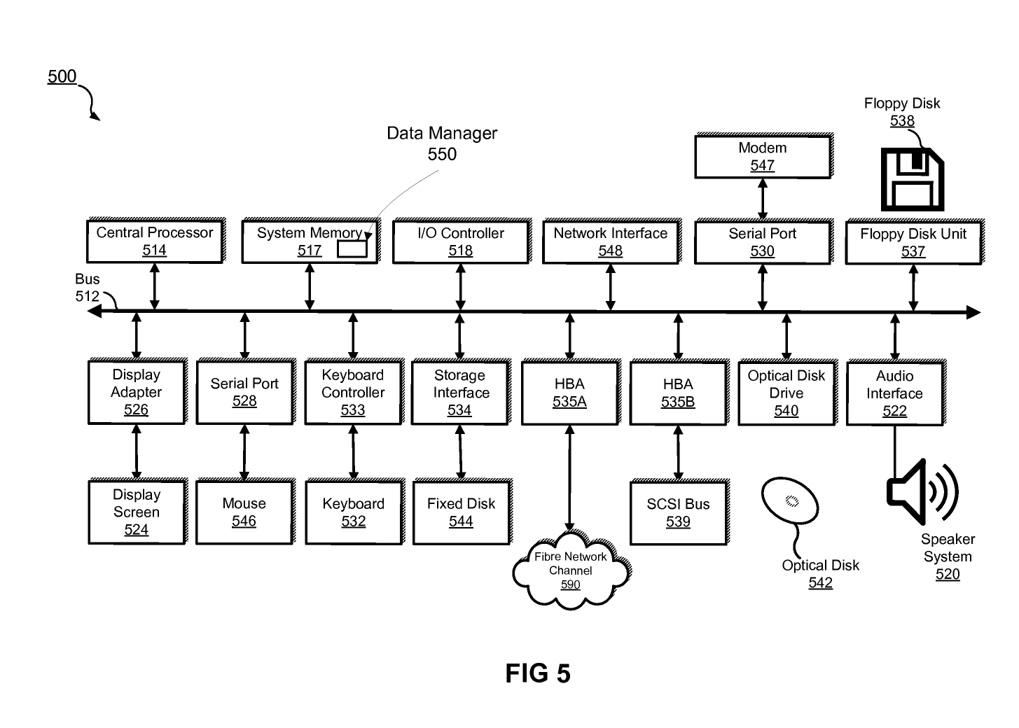

Referring now to FIG. 5, a block diagram of another computer system in accordance with some embodiments is shown. FIG. 5 depicts a block diagram of a computer system 510 suitable for implementing the present disclosure. Computer system 510 includes a bus 512 which interconnects major subsystems of computer system 510, such as a central processor 514, a system memory 517 (typically RAM, but which may also include ROM, flash RAM, or the like), an input/output controller 518, an external audio device, such as a speaker system 520 via an audio output interface 522, an external device, such as a display screen 524 via display adapter 526, serial ports 528 and 530, a keyboard 532 (interfaced with a keyboard controller 533), a storage interface 534, a floppy disk drive 537 operative to receive a floppy disk 538, a host bus adapter (HBA) interface card 535A operative to connect with a Fibre Channel network 590, a host bus adapter (HBA) interface card 535B operative to connect to a SCSI bus 539, and an optical disk drive 540 operative to receive an optical disk 542. Also included are a mouse 546 (or other point-and-click device, coupled to bus 512 via serial port 528), a modem 547 (coupled to bus 512 via serial port 530), and a network interface 548 (coupled directly to bus 512). It is appreciated that the network interface 548 may include one or more Ethernet ports, wireless local area network (WLAN) interfaces, Bluetooth interfaces, Zigbee interfaces, Z-Wave interfaces, etc., but are not limited thereto. System memory 517 includes a data manager module 550 which is operable to manage links (e.g., primary links and redundant links) within the network. According to one embodiment, the data manager module 550 may include other modules for carrying out various tasks. For example, the data manager module 550 may include the link manager module 422, the path manager module 424, the data rerouter module 426, and the data cacher module 428, as discussed with respect to FIG. 4 above. It is appreciated that the data manager module 550 may be located anywhere in the system and is not limited to the system memory 517. As such, residing of the data manager module 550 within the system memory 517 is merely exemplary and not intended to limit the scope of the embodiments. For example, parts of the data manager module 550 may reside within the central processor 514 and/or the network interface 548 but are not limited thereto.

Bus 512 allows data communication between central processor 514 and system memory 517, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 510 are generally stored on and accessed via a computer readable medium, such as a hard disk drive (e.g., fixed disk 544), an optical drive (e.g., optical drive 540), a floppy disk unit 537, or other storage medium. Additionally, applications can be in the form of electronic signals modulated in accordance with the application and data communication technology when accessed via network modem 547 or interface 548.

Storage interface 534, as with the other storage interfaces of computer system 510, can connect to a standard computer readable medium for storage and/or retrieval of information, such as a fixed disk drive 544. Fixed disk drive 544 may be a part of computer system 510 or may be separate and accessed through other interface systems. Network interface 548 may provide multiple connections to other devices. Furthermore, modem 547 may provide a direct connection to a remote server via a telephone link or to the Internet via an internet service provider (ISP). Network interface 548 may provide one or more connection to a data network, which may include any number of networked devices. It is appreciated that the connections via the network interface 548 may be via a direct connection to a remote server via a direct network link to the Internet via a POP (point of presence). Network interface 548 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 5 need not be present to practice the present disclosure. The devices and subsystems can be interconnected in different ways from that shown in FIG. 5. The operation of a computer system such as that shown in FIG. 5 is readily known in the art and is not discussed in detail in this application. Code to implement the present disclosure can be stored in computer-readable storage media such as one or more of system memory 517, fixed disk 544, optical disk 542, or floppy disk 538. The operating system provided on computer system 510 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments disclosed. Many modifications and variations are possible in view of the above teachings.

What is claimed is:

1. A system comprising:
a plurality of devices forming a communication network, wherein the plurality of devices is networked via their respective primary link, wherein the plurality of devices is configured to revert to a redundant network upon a primary link associated with a first device in the plurality of devices failing; and
a second device in the plurality of devices configured to transmit data to the first device through the primary link associated with the first device when the primary link associated with the first device is operational, wherein the second device is further configured to reroute the data through a secondary link associated with the first device in response to the primary link associated with the first device failing, and wherein the redundant network includes the secondary link associated with the first device.

2. The system as described in claim 1, wherein the second device is further configured to determine whether a path through the redundant network to the first device exists in case of the primary link associated with the first device failing.

3. The system as described in claim 1, wherein the second device is further configured to select a path from a plurality of paths through the redundant network to reroute the data to the first device.

4. The system as described in claim 3, wherein the selected path comprises the secondary link.

5. The system as described in claim 1, wherein the primary link associated with the first device is associated with a first communication interface, wherein the secondary link associated with the first device is associated with a second communication interface, wherein the first communication interface differs from the second communication interface.

6. The system as described in claim 5, wherein the first communication interface is based on a wired link, and wherein the second communication interface is based on a wireless link.

7. The system as described in claim 6, wherein the second communication interface is a radio frequency (RF) interface.

8. The system as described in claim 6, wherein the second communication interface is a Wi-Fi, Bluetooth, Ultra Wide Band (UWB) 802.15.3a, 802.11af/White-Fi,802.11ax, Zigbee 802.15.4, or Z-Wave ITU-T G.9959 interface.

9. The system as described in claim 1, wherein the redundant network is a data traffic context aware redundant network.

10. A system comprising:
a plurality of devices forming a communication network, wherein the plurality of devices is networked via their respective link; and
first and second devices in the plurality of devices configured to send and receive data with each other through the communication network, wherein the second device is further configured to receive from the first device data destined for the second device, and wherein the first device is further configured to cause a caching device in the plurality of devices to cache the data destined for the second device in response to the link associated with the second device failing and further in response to determining absence of an alternative path from the first device to the second device.

11. The system as described in claim 10, wherein the first device is further configured to resume transmitting to the second device the data destined for the second device upon detecting that the link associated with the second device is functional again subsequent to the link associated with the second device failing.

12. The system as described in claim 10, wherein the first device is further configured to cause the caching device to transmit to the second device cached data destined for the second device upon detecting that the link associated with the second device is functional again subsequent to the link associated with the second device failing.

13. The system as described in claim 10, wherein the first device is further configured to cause another caching device in the plurality of devices to continue caching the data destined for the second device when the caching device can no longer cache the data destined for the second device.

14. The system as described in claim 10, wherein the first device is further configured to cause another caching device in the plurality of devices to simultaneously cache a portion of the data destined for the second device while the caching device caches a remaining portion of the data destined for the second device.

15. The system as described in claim 10, wherein the first device and devices of the plurality of devices other than the second device form a redundant network in response to the link associated with the second device failing.

16. A system comprising:
a plurality of devices forming a communication network, wherein the plurality of devices is networked via their respective primary link; and
a first device in the plurality of devices configured to transmit data to a second device in the plurality of devices through the primary link associated with the second device when the primary link associated with the second device is operational, wherein the first device is further configured to reroute the data through a redundant link associated with the second device in response to the primary link associated with the second device failing and further in response to existence of a path from the first device to the second device, and wherein the first device is further configured to cause a caching device in the plurality of devices to cache the data in response to the primary link associated with the second device failing and further in response to absence of the path from the first device to the second device.

17. The system as described in claim 16, wherein the first device is further configured to cause the caching device to transmit the cached data to the second device upon detecting that the primary link is functional again subsequent to the primary link associated with the second device failing.

18. The system as described in claim 16, wherein the first device and devices in the plurality of devices form a redundant network in response to the primary link associated with the second device failing, wherein the first device is further configured to use a plurality of different communication interfaces to reroute the data to the first device along different paths of a plurality of paths through the redundant network.

19. The system as described in claim 18, wherein the plurality of different communication interfaces comprises a wired interface and a wireless interface.

20. The system as described in claim 19, wherein the wireless interface is a radio frequency (RF) interface.

21. The system as described in claim 19, wherein the wireless interface is a Bluetooth interface.
